(19) United States
(12) Patent Application Publication
(10) Pub. No.: US 2004/0081781 A1
(43) Pub. Date: Apr. 29, 2004

(54) Composition, kits and method for providing a substrate with barrier properties and uses thereof

(76) Inventors: Charles Corby, Lamorlaye (FR); Philippe David, Amiens (FR)

Correspondence Address: MORGAN LEWIS & BOCKIUS LLP, 1111 PENNSYLVANIA AVENUE NW, WASHINGTON, DC, 20004, US

(21) Appl. No.: 10/312,997

(22) PCT Filed: Jul. 2, 2001
(86) PCT No.: PCT/FR01/02114

(30) Foreign Application Priority Data
Jul. 3, 2000 (FR) 00/08595

(51) Int. Cl. C08L 5/00; C08L 89/00; C08L 93/00; C09D 105/00; C09D 189/00; C09D 193/00

(52) U.S. Cl. 428/35.7; 106/144.3; 106/146.2; 106/147.1; 106/147.6; 106/205.4

(57) ABSTRACT

The invention concerns a composition for providing a substrate, after said substrate has been coated, with barrier properties to oils and greases, and complementarily to water. The invention is characterised in that it is obtainable by dispersion, at a temperature ranging between room temperature and about 70° C., of at least a film-forming gum or resin, not water-soluble and solubilized in at least a water-miscible solvent, in an aqueous solution containing at least a water soluble and lipophobic film-forming compound selected among proteins, polysaccharides and their mixtures, said composition having a temperature ranging between room temperature and about 70° C. The invention also concerns a method for preparing said composition, kits containing same, and a method for providing a substrate with barrier properties, and their uses, in particular for making packages and particularly packages for foodstuff.

The present invention relates to a composition capable of imparting oil-barrier and fat-barrier properties, and also water-barrier properties, to a substrate, after coating this substrate, and to a method for preparing this composition, and also to kits containing it.

The invention also relates to a method for imparting barrier properties to a substrate.

Finally, the invention relates to the uses of said composition, to kits and to said method, especially for producing wrappings, and in particular wrappings intended for packaging foodstuffs.

Food packaging is a sector in which certain synthetic polymers, especially certain thermoplastic materials, have acquired a predominant position in recent decades on account of their oil-, fat- and water-barrier properties, their ability to be used in very varied forms, and especially in the form of flexible films that can withstand being folded or stretched, their relative inertness with respect to foods and their low cost.

Thus, whether the products concerned are grocery products, for instance fresh, frozen, deep-frozen, cooked or dried products, they are now all commonly packaged in wrappings that consist of thermoplastic materials, either in replacement for more traditional materials such as paper, cardboard and metal, or in the form of complexes in which these materials are combined, for example by coating or laminating, with such materials.

Among these thermoplastic materials, polyethylenes, polypropylenes, polyesters, polyvinyl chlorides, polystyrenes and polyvinylidene chlorides are the ones most frequently used.

Although it is undeniable that the use of thermoplastic materials has greatly improved the conditions of transportation, storage and distribution of foodstuffs, and in particular of perishable foodstuffs, especially by reducing the risks of impairment of these foodstuffs and of their packagings, it has, on the other hand, the major drawback of constituting an appreciable burden on the environment. Specifically, it is well known that the common thermoplastics are degraded little if at all by microorganisms and are moreover very difficult to recycle.

Since the mid-1980s, professionals in the food industry have slowly but steadily become conscious of the need to limit the amount of waste generated by packagings. This acquisition of awareness, largely encouraged by public authorities, has led them to search, for the packaging of their products, for materials that are biodegradable or at the very least recyclable so as to be as nonpolluting as possible, while at the same time having the advantages of thermoplastic materials.

Accordingly, numerous studies have been performed in the last fifteen years with a view to providing materials or methods for obtaining wrappings, and especially highly biodegradable films capable of coming into contact with food, or even edibles. Thus, for example:

French patent application No. 88 15336 proposes to prepare an edible film from a material consisting mainly of a soft wheat flour with a low protein content and a plasticizer, which are both in suspension in water;

French patent application No. 93 06963 describes a composition intended for manufacturing a biodegradable film and comprising an alginate, a plasticizer and a tanning material such as alum, dissolved in water, and also a metal salt capable of improving the gelation of said alginate;

European patent application No. 0 547 551 describes a composition capable of being used for the manufacture of an edible film and comprising modified starch, gelatin, a plasticizer, lipids and water;

European patent application No. 0 593 123 proposes to produce an edible film from an aqueous suspension of water-insoluble proteins;

European patent application No. 0 610 915 describes a method for manufacturing a biodegradable film from a dispersion of zein in a water/acetone mixture;

European patent application No. 0 935 921 proposes to use, to produce an edible film, a mixture comprising, as main constituent, konjac flour that has been made insoluble beforehand by deacetylation, and, as secondary constituents, agar and gelatin;

International PCT patent application No. WO 95/02339 describes the preparation of a film for coating foods or medicinal products starting with an aqueous dispersion of shellac, this dispersion being obtained by dissolving the shellac in an alkaline solution, and then adding an acidic solution so as to obtain a precipitation of said shellac, and being concentrated before applying it to the component to be coated; while

International PCT patent application No. WO 99/43497 describes a complex biodegradable film obtained by superposition of one or more layers of a polylactide and one or more layers of a sodium or potassium caseinate.

It is found that the films thus obtained are not really satisfactory, since they are generally highly water-sensitive and have mediocre mechanical properties, are not sufficiently heat-sealable and are expensive.

Moreover, fluoro compounds, generally applied by means of organic solvents, are commonly used for treating cellulose materials, in particular of the paper or cardboard type, with the aim of making them impermeable to oils and fats. Other products of petrochemical origin are also used to provide a water barrier for the complexes thus formed. Besides the fact that the products thus obtained occasionally pose problems of toxicity when they are placed in contact with foods, their incineration may lead to the formation of corrosive and often toxic compounds, and the persistence of some of these derivatives in the environment appears to be problematic. Furthermore, a noncellulosic portion of these products is not biodegradable either.

It is for this reason that the inventors set themselves the aim of providing a composition and a method for imparting barrier properties to a substrate, so as to make it suitable for use especially in the wrapping of foodstuffs, and to do so without the acquisition of these properties being reflected by a burden on the environment.

These aims are achieved, according to the invention, by a composition that is characterized in that it may be obtained by dispersing, at a temperature between room temperature and about 70° C., at least one film-forming resin or gum, preferably of natural or biotechnological origin, which is insoluble in water and soluble in at least one water-miscible solvent, for example an alcohol, a carbonyl solvent or a polyol ether, in an aqueous solution containing at least one water-soluble and lipophobic film-forming compound chosen from proteins, polysaccharides and mixtures thereof, said composition having a temperature that is sufficient to obtain a liquid mixture and a fluidity that allows its uniform and homogeneous application to a support such as, for example, paper. Depending on the film-forming compounds used, the temperature of said composition will be between room temperature and about 70° C.

Specifically, the inventors have demonstrated, unexpectedly, that by precipitating a film-forming resin or gum, preferably of natural or biotechnological origin (for example obtained by fermentation or enzymatically), in the form of microparticles (ideally less than 10 μm) in an aqueous solution of a protein or a polysaccharide or a suitable mixture of proteins and polysaccharides that is also of film-forming nature—which is produced if this gum or resin is dispersed in said solution at a temperature at which the solution has a satisfactory fluidity—, a composition is obtained, which, when applied to a substrate, imparts oil- and fat-barrier properties to said substrate, and also a certain level of water resistance.

Furthermore, when the substrate is of low porosity or nonporous, this composition forms at the surface a film that places little burden on the environment, which has, besides oil- and fat-barrier properties, depending on the formulations, properties of heat-sealability, of suitability for food contact and of transparency as a dry thin film, making said composition entirely suitable for use in the manufacture of wrappings for packaging foodstuffs.

According to a first advantageous arrangement of the composition, the water-soluble and lipophobic film-forming compound is chosen from proteins, preferably proteins of animal origin, and especially from gelatins, egg proteins and milk proteins, in particular sodium caseinates.

Among the gelatins that may especially be mentioned are the A-type gelatins (i.e. those obtained by acidic hydrolysis of collagen) which have a gel strength of between about 150 and 280 Bloom BS (British Standard) as measured according to AFNOR standard NF V 59-001. They may be used alone or in combination with other gelatins, but of lower gel strength, for example less than or equal to 100 Bloom BS, provided that the latter do not represent more than 50% (w/w) of the total amount of gelatins present in the composition.

It is also possible, in accordance with the invention, to envisage using basic gelatins (i.e. those obtained by basic hydrolysis of collagen).

When the water-soluble film-forming compound is chosen from gelatins, the dispersion of the film-forming gum or resin in the gelatin solution will preferably be performed with a gelatin solution brought to a temperature of between about 40° C. and 70° C.

In accordance with the invention, the water-soluble and lipophobic film-forming compound may also be chosen from polysaccharides, in which case an alginate or a carrageenan such as, for example, kappa-carrageenan is preferably used.

According to another embodiment of the invention, the water-soluble and lipophobic film-forming compound is a mixture of proteins and polysaccharides. As examples of polysaccharides that may be used in such mixtures, mention may be made of Satialgine BDG75™, which is an alginate sold by the company DEGUSSA, and SATIAGEL ME5™, sold by the company DEGUSSA, which is a kappa-carrageenan.

When the water-soluble and lipophobic film-forming compound is chosen from mixtures of proteins and polysaccharides, the polysaccharides will preferably be present in an amount of less than or equal to 10% (w/w) relative to the water-soluble lipophobic film-forming compounds as a whole.

According to another advantageously arrangement of the composition, the film-forming resin or gum is a natural resin or gum, and especially a shellac.

Among the various shellacs available on the market, those that are dewaxed and bleached are particularly preferred.

Dammar resin may, for example, also be used alone or as a mixture with shellac. Other products such as sandarac gum or hydrogenated colophony may, for example, be used, essentially as a mixture with the shellac or dammar resin.

Although it is preferred to use, in the context of the present invention, film-forming polymers of natural origin, it goes without saying that it is also possible to prepare a composition in accordance with the invention from proteins, polysaccharides and/or synthetic or biosynthetic gums, provided that these synthetic polymers have suitable Theological properties during application and suitable film-forming and solubility properties.

According to yet another advantageous arrangement of the composition, the film-forming resin or gum represents not more than 70% (w/w) and preferably not more than 50% (w/w) of the amount of water-soluble and lipophobic film-forming compound(s) present in this composition.

In accordance with the invention, the film-forming resin or gum is preferably dispersed in the aqueous solution containing the water-soluble and lipophobic film-forming compound, by adding a solution of this gum or resin in an effective water-miscible solvent, the solvent phase of which solution has a water content of not more than 5% and preferably not more than 1% (v/v).

For the purposes of the present invention, the term “effective solvent” means any liquid that effectively dissolves the resin or gum, at a sufficient concentration at the temperature of preparation of the formulation or at room temperature. The effective, water-miscible solvent for the gum or resin may be chosen especially from the alcohols or carbonyl solvents as defined in the present description.

Advantageously, the aqueous solution has a content of water-soluble and lipophobic film-forming compound(s) of between about 20 and 40% (w/v), while the solution of resin or gum has a content of film-forming resin(s) or gum(s) of between about 20 and 50% (w/v).

When the effective, water-miscible solvent for the gum or resin is chosen from alcohols, the alcohol used for this purpose is preferably a C₁-C₄ monoaliphatic alcohol, and in particular ethanol. However, it clearly possible to use methanol, propanol or butanol and also mixtures of these various alcohols, carbonyl solvents, polyol ethers or glycerol.

Among the carbonyl solvents that allow the solubilization of the film-forming gum or resin, mention may be made especially of acids and esters thereof such as glacial acetic acid and methyl acetate, and ketone solvents such as acetone. Mixtures of these various solvents may also be used, provided that they allow the solubilization of the film-forming gum or resin.

A solvent of polyol ether type that may especially be mentioned is dipropylene glycol methyl ether.

According to one variant of the invention, the film-forming resin or gum, which is normally insoluble in water and soluble in at least one water-miscible solvent, such as alcohols and carbonyl solvents, is dispersed in the aqueous solution containing the water-soluble and lipophobic film-forming compound by addition of a modified aqueous solution of this film-forming resin or gum. The expression “modified aqueous solution” means an aqueous solution obtained by modifying the pH or the ionic strength of the medium so as to dissolve the resin or gum. Advantageously, this resin or gum is present in the modified aqueous solution in an amount ranging from 20 to 50% (w/v). Modified aqueous solutions of shellac gum are described, for example, in International patent application W095/02339.

According to yet another advantageous arrangement of the composition, it furthermore comprises at least one plasticizer, the function of which is to increase the ability of said composition to form a deformable and flexible film at the surface of a substrate.

This plasticizer must have good compatibility with the water-soluble and lipophobic film-forming compound/water couple so as to avoid a phase separation arising during the hot drying of the composition after coating the substrate. It is preferably chosen from plasticizers approved “for food contact”, for instance polyols of the type such as glycerol, sorbitol, mannitol, xylitol, or a glycol ether. However, it is possible for it not to satisfy the latter criterion when the composition is intended for uses that do not need such an approval.

Preferably, the plasticizer represents not more than 30% (w/w) of the total amount of solids present in the composition.

The composition according to the invention may also comprise one or more adjuvants chosen as a function of the additional properties that it is desired to impart to the substrate or at least to the surface(s) of this substrate coated with the composition. Thus, said composition may especially comprise:

at least one hydrophobic release agent, for instance a fatty acid mono-, di- or triglyceride or a salt of such a glyceride, that is capable of avoiding the adhesion of the substrate to another substrate or to itself if it comes to be folded;

at least one opacifying pigment, for instance titanium oxide;

at least one filler preferably chosen from mineral fillers;

at least one anti-oxidant agent, for instance sorbic acid, or an antimicrobial agent, for instance sodium sulfite or citric acid; or

at least one antifoam compound;

at least one food additive such as a colorant or a flavoring, intended to give the substrate particular organoleptic characteristics.

In accordance with the invention, the composition described above may be used as soon as it is prepared or, in contrast, after an delay. In the latter case, once the film-forming resin or gum has been dispersed, and once the plasticizer and/or adjuvant(s) has (have) been added, where appropriate, the composition may be packaged in unmodified form, for example in wrappings of the type such as drums with a leaktight closure and, preferably, with total opening, in which case this packaging, when the preparation has been performed under hot conditions, is preferably performed while the composition is still hot and, consequently, liquid.

However, in the case of delayed use, this composition may also be subjected to a more or less thorough dehydration operation, preferably at low temperature, i.e. in practice at a temperature below 50° C., and package it in a form concentrated in active materials, or even in a dry form of the type such as flakes, lyophilizates or the like, in wrapping that allows it to be stored protected from moisture. The composition will then be reconstituted, by rehydration with a suitable volume of water, prior to using it for coating a substrate.

In a certain number of cases, it is desirable, or even essential, for the composition to impart to the substrate onto which it will be deposited, in addition to oil- and fat-barrier properties, suitable water-barrier and water-resistance properties.

In accordance with the invention, these water-barrier and water-resistance properties may be obtained especially by introducing into the composition at least one agent capable of insolubilizing the water-soluble and lipophobic film-forming compound, or of inducing its crosslinking during the hot drying of said composition after it has been applied to the substrate.

As examples of agents capable of insolubilizing the water-soluble and lipophobic film-forming compound, mention may be made of water-soluble metal salts, for instance calcium chloride and aluminum sulfate, and water-insoluble metal salts, for instance aluminum, calcium, magnesium and zinc stearates.

This insolubilizer is preferably incorporated into the composition during the dispersing of the film-forming gum or resin if it has a water-insoluble nature, or only after dispersing the film-forming resin or gum and, where appropriate, adding plasticizer and/or adjuvant(s) if it has a water-soluble nature, except if the composition is intended to be subjected to a dehydration operation. Specifically, in the latter case, it is desirable to incorporate the insolubilizer into the composition only after it has been rehydrated.

In any event, the amount of insolubilizer added to the composition is such that said insolubilizer preferably represents not more than 15% (w/w) of the total amount of solids present in said composition.

As examples of agents capable of inducing the crosslinking of the water-soluble and lipophobic film-forming compound, mention may be made of the aldehyde compounds approved “for food contact”, for instance glyoxal and glutaraldehyde. However, it is also possible to use a urea-formaldehyde, melamine-formaldehyde or epoxy resin when the composition is intended for uses that do not need such an approval.

In accordance with the invention, this crosslinking agent may be incorporated into the composition after dispersing the film-forming resin or gum, where appropriate adding plasticizer and/or adjuvant (s) and cooling this composition slightly, if the composition was prepared under hot conditions (so that its temperature is about 45-50° C., for example in the case of a composition based on shellac and gelatin), with the proviso that, in the case of a delayed use of the composition, this agent is entirely unsuitable for reacting before drying said composition. The amount of insolubilizer added to the composition is such that said insolubilizer preferably represents not more than 5% (w/w) of the total amount of solids present in this composition.

As a variant, the crosslinking agent may be incorporated into the composition, also preferably in proportions of not more than 5% (w/w) of the total amount of solids, just before said composition is applied to the substrate. This will especially be the case when the composition is subjected to a dehydration operation to store it, and a rehydration operation to use it.

As a further variant, the crosslinking agent may be sprayed or applied by any other means to this composition, after applying said composition to the substrate, but preferably before said composition is dry, in which case this spraying is advantageously performed using an aqueous solution containing not more than 5% (w/v) of crosslinking agent.

In accordance with the invention, the water-barrier and water-resistance properties may also be obtained by applying to the composition, after coating the substrate with said composition, an additional treatment that may consist especially of:

an “overcoating” with one or more layers of an alcoholic solution containing at least one film-forming resin or gum, preferably identical to the one present in the composition, in which case a solution in an effective water-miscible solvent for the gum or resin, the content of film-forming gum(s) of which is between about 20 and 50 (w/v) and the solvent phase of which has a water content of not more than 5% and, if possible, not more than 1% (v/v) is preferably used; it may also be envisioned to use a modified aqueous solution (of modified pH or ionic strength) of film-forming resin or gum as described above, the content of film-forming resin or gum of which is between about 20 and 50% (w/v); or

of a treatment with radiation (for example ultraviolet radiation).

A subject of the present invention is also a method for preparing a composition as defined above, which method is characterized in that it comprises:

a) the dispersion of at least one film-forming resin or gum, preferably of natural or biotechnological origin, which is insoluble in water and soluble in at least one water-miscible solvent chosen from alcohols, carbonyl solvents and polyol ethers, in an aqueous solution containing at least one water-soluble and lipophobic film-forming compound chosen from proteins, polysaccharides and mixtures thereof, the composition obtained having a temperature that is sufficient to obtain a liquid mixture with a fluidity that allows its uniform and homogeneous application to a support, such as, for example, paper. Depending on the film-forming compounds used, the composition will be between room temperature and about 70° C.; and optionally

b) the addition to the resulting mixture of at least one plasticizer and/or of at least one adjuvant chosen in particular from hydrophobic release agents, opacifiers, anti-oxidants, antimicrobial, antifoams agents, colorants, fillers (preferably mineral fillers) and flavorings.

According to a first preferred embodiment of this method, it furthermore comprises the incorporation into the composition:

either of at least one agent capable of insolubilizing the water-soluble and lipophobic film-forming compound, during the hot drying of the composition, in which case this incorporation is performed during step a) when this agent is water-insoluble, or after step b) in the opposite case;

or of at least one agent capable of inducing the crosslinking of said film-forming compound during the hot drying of the composition, in which case this incorporation is performed after step b), on condition that, in the event of a delayed use of the composition, this agent is incapable of reacting before said composition has dried.

Alternatively, and throughout the present description, the agent capable of insolubilizing the film-forming compound and/or the agent capable of inducing the crosslinking of said film-forming compound will be sprayed or applied to the surface by any other means after applying the formulation to the support and optionally drying by any suitable means.

According to another preferred embodiment of this method, it furthermore comprises partially or totally dehydrating the composition to conserve it in a form concentrated in active materials or in a dry form, followed by rehydrating it with a suitable volume of water in order to use it to coat a substrate.

According to one particularly advantageous arrangement of this preferred embodiment, the method also comprises the incorporation into the composition, after rehydration of said composition:

either of at least one agent capable of insolubilizing the water-soluble and lipophobic film-forming compound, during the hot drying of the composition, in which case this agent is preferably a water-soluble agent;

or of at least one agent capable of inducing the crosslinking of said film-forming compound during the hot drying of the composition.

A subject of the present invention is also a kit or device that is useful for imparting barrier properties to a substrate and that comprises at least two compartments, which kit is characterized in that the first compartment contains a composition as defined above, while the second compartment contains at least one agent capable of insolublizing or of inducing the crosslinking of the water-soluble and lipophobic film-forming compound, present in said composition, during the hot drying of said composition.

A further subject of the present invention is a kit or device that is useful for imparting barrier properties to a substrate and that comprises at least two compartments, which kit is characterized in that the first compartment contains a composition as defined above, while the second compartment contains at least one film-forming resin or gum, which is preferably identical to the resin or gum present in said composition, dissolved in a suitable medium: either an effective solvent for the film-forming resin or gum, said solvent being water-miscible, such as, for example, an alcoholic solution; or an aqueous solution whose pH or ionic strength has been modified in order to dissolve the film-forming resin or gum therein.

A subject of the present invention is also a kit or device that is useful for imparting barrier properties to a substrate and that comprises at least two compartments, which kit is characterized in that the first compartment contains at least one water-soluble and lipophobic film-forming compound, optionally in aqueous solution, while the second compartment contains at least one film-forming resin or gum, dissolved in a suitable medium: either an effective solvent for the film-forming resin or gum, said solvent being water-miscible, such as, for example, an alcohol; or an aqueous solution whose pH or ionic strength has been modified in order to dissolve the film-forming resin or gum therein.

In these latter two kits, the solution of film-forming resin or gum present in the second compartment preferably has a content of film-forming resin(s) or gum(s) of between about 20 and 50% (w/v). When it is a solution in an alcohol, in a carbonyl solvent, in a polyol ether solvent or in glycerol, the solvent phase preferably has a water content of not more than 5% and, if possible, not more than 1% (v/v).

Another subject of the present invention is a method for imparting barrier properties to a substrate, which method comprises the coating of this substrate with one or more layers of a composition in accordance with the invention, and the hot drying of this or these layers.

In accordance with the invention, it is desirable for the composition to have, when it is applied to the substrate, a solids content of between about 10 and 60% (w/v).

Consequently, the method may furthermore comprise, prior to coating the substrate:

the rehydration of the composition with water until a solids content of between 10 and 60% (w/v) is obtained, when this composition is in dry form; or the adjustment of the solids content of the composition to a value of between 10 and 60% (w/v), when this composition, although in wet form, does not have a suitable solids content.

Moreover, the method may also comprise, prior to coating the substrate, the heating of this composition to a temperature such that the composition has a fluidity that allows it to be applied uniformly and homogeneously to said substrate; for example between about 25 and 70° C. depending on the film-forming compounds used.

In particular, in the case of a formulation based on gelatin and shellac, it is desirable for the composition to have, during the coating of the substrate, a temperature of at least 50° C., but ideally not exceeding 70° C., such that its fluidity is sufficient to uniformly and homogeneously deposit this composition on said substrate.

The substrate may be coated with the composition by any technique that allows direct coating onto a support, and especially techniques of coating on a paper/card machine of the press size type and derivatives, roll doctor and derivatives, smoothing or trailing blades and derivatives, or off-machine, of the air-knife, reverse-etching or reverse-roll type, or alternatively by printing techniques (in particular using an engraved roll).

In any case, it is preferred, in the context of the present invention, to deposit, for each layer, about 10 to 20 g of composition per m² of substrate depending on the apparatus used, so as to obtain a layer that, once dry, has a weight per unit area (or grammage) of between about 2 and 10 g/m², depending on the solids content of the composition deposited.

In accordance with the invention, the substrate may be coated with one or more layers of composition depending on the desired level of barrier efficiency, in which case each layer is preferably subjected to a drying operation before applying the next layer.

These drying operations, which may be performed by any technique conventionally used in the paper industry for coating paper and cardboard, and especially by passing through a tunnel oven equipped, for example, with infrared radiants, are preferably performed at a temperature of between about 80 and 100° C.

When it is desired to impart to the substrate not only oil- and fat-barrier properties, but also water-barrier and water-resistance properties, using a composition that is free of agents capable of insolubilizing or of inducing the crosslinking of the water-soluble and lipophobic film-forming compound, present in said composition, these water-barrier and water-resistance properties may advantageously be obtained:

either by applying, by spraying or by any suitable means, onto the outermost layer of composition or between the various layers of this composition, a crosslinking agent that is preferably in the form of an aqueous solution, in which case this application is advantageously performed while said layer(s) of composition is (are) only partially dry;

or by depositing, onto the outermost layer of composition, one or more layers of a solution, in particular an alcoholic solution, containing at least one film-forming resin or gum, which is preferably identical to the resin or gum present in the composition, in which case this deposition is advantageously performed once said layer of composition is dry;

or alternatively by applying a radiation treatment (for example ultraviolet radiation) to the film, in which case, here also, this treatment is advantageously performed once the outermost layer of composition is dry.

According to a preferred embodiment of the method in accordance with the invention, the substrate that is coated with composition is a cellulosic substrate such as paper, cardboard, wood or textile based on cellulose fibers, for instance a cotton fabric or a viscose nonwoven.

However, this substrate may also be of a different nature and may consist, for example, of a synthetic textile or nonwoven, a food product, for instance a fruit, a pharmaceutical, cosmetic or dietetic composition, or alternatively a seed.

The invention has many advantages. Specifically, it makes it possible to impart oil- and fat-barrier properties to a substrate, combined, if so desired, with water-barrier and water-resistance properties with respect to water in all its forms (liquid and vapor), and can do so virtually irrespective of the nature and porosity of this substrate.

Since the composition in accordance with the invention may be prepared mainly from natural compounds, coating it onto a substrate is not of a nature to disrupt the ability of this substrate to be degraded by microorganisms or recycled.

The substrate, once coated with the composition that is the subject of the invention, has the following advantages:

very satisfactory plasticity and flexibility, while at the same time being mechanically strong,

ability to be heat-sealed and printed, depending on the formulations,

a naturally translucent or transparent appearance, depending on the formulations and on their thickness,

very good bonding ability, for example with hot-melt or aqueous vinyl products,

little environmental burden on account of its optimum biodegradability and the absence of harmful incineration waste, and

absence of toxicity.

Finally, the manufacturing costs for the composition and the kits in accordance with the invention, and also the costs of implementing the method to impart barrier properties to a substrate are entirely compatible with industrial imperatives.

Consequently, the invention may find many uses, among which mention may be made, without this having any limiting nature, of: the production or wrappings, and especially of wrappings for packaging foodstuffs, for instance the manufacture of wrapping papers for fresh products after slicing, the impermeabilization to oils, fats and water of cardboard boxes for food use of the type such as pizza boxes, pastry boxes, or intended to protect dry products (for example human food or pet food) or alternatively wrapping components made of wood such as, for example, crates for transporting fruit and the manufacturing stoppering devices,

the protection or improvement of supports intended to be used in photography, photocopying or photo type-setting,

the topping and coating of foods,

the production of films for separating two media of different composition, such as, for example, filled biscuits,

the production of hygiene products made of paper, cardboard or nonwoven (diapers, feminine sanitary protections, etc.),

the coating and encapsulating of active materials, for instance medicinal active principles, food additives, pharmaceutical, cosmetic or dietetic compositions, or alternatively

the coating of seeds.

The invention will be understood more clearly with the aid of the remainder of the description hereinbelow, which refers to examples of implementation of the invention.

It goes without saying, however, that the remainder of the description is given purely for the purposes of illustrating the invention and does not in any way constitute a limitation thereof.

### EXAMPLE 1

### Preparation of a Composition in Accordance with the Invention

A 35% ethanolic solution of dewaxed and bleached shellac (ALLAND and ROBERT company—Reference 5739) is prepared, several hours in advance, by adding this shellac to absolute ethanol with moderate stirring, and the mixture is left to stand until a clear solution is obtained.

Separately, an aqueous 20% solution of a gelatin A with a gel strength of between 250 and 280 Bloom BS (SKW GELATIN SPECIALTIES company—Reference PS) is prepared by adding this gelatin to water at a temperature of about 40° C. with moderate stirring, followed by raising the temperature of the mixture to about 60-65° C. so as to completely dissolve the gelatin in the water.

The ethanolic shellac solution is added, with vigorous stirring, to the hot aqueous gelatin solution, in a proportion of 14.3 g of alcoholic solution per 100 g of aqueous solution, while keeping the temperature at about 60° C.

Next, 2 g of glycerol and 1 g of release fatty acid triglycerides (such as PAN OIL EXTRAFLUIDE SPECIAL from the company STEARINE DUBOIS) are incorporated into the resulting mixture while it is still hot.

The composition thus prepared is ready for use. It has a solids content of about 24%.

### EXAMPLE 2

### Preparation of a Composition in Accordance with the Invention

A 30% ethanolic solution of dewaxed and bleached shellac (ALLAND and ROBERT company—Reference 5739) is prepared, several hours in advance, by adding this shellac to absolute ethanol with moderate stirring, and the mixture is left to stand until a clear solution is obtained.

Magnesium stearate (STEARINERIE DUBOIS company) is added to this solution, with moderate stirring, in a proportion of 22.5 g of magnesium strearate per 100 g of alcoholic shellac solution.

The mixture thus obtained is introduced, with vigorous stirring, into an aqueous 20% solution of gelatin A prepared in accordance with example 1, the only difference being that the gelatin A used has a gel strength of between 180 and 200 Bloom BS, in a proportion of 33 g of alcoholic solution per 100 g of aqueous solution, while keeping the temperature at about 60° C.

Next, 2 g of glycerol and 1 g of release fatty acid triglycerides (such as PAN OIL EXTRAFLUIDE SPECIAL from STEARINE DUBOIS) are incorporated into the resulting mixture while it is still hot.

The composition thus prepared is ready for use. It has a solids content of about 28%.

### EXAMPLE 3

### Preparation of a Composition in Accordance with the Invention

100 g of a solution of dewaxed and bleached shellac are prepared and 22.5 g of magnesium stearate are added thereto, as indicated above in example 2.

33 g of the mixture thus obtained are introduced, with vigorous stirring and at room temperature, into 100 g of an aqueous 15% w/w mixture of sodium caseinate, prepared by adding, with moderate stirring, caseinate powder (“Spray-Dried” low-viscosity food-grade sodium caseinate No. 80205D sold by the company LACTALIS INDUSTRIE, Rennes, France) to demineralized water at 20° C., followed by stirring for at least 30 minutes.

The composition obtained, which is liquid at room temperature, is ready for use. It has a solids content of about 21.7%.

### EXAMPLE 4

### Coating of a Substrate with a Composition in Accordance with the Invention

A composition corresponding to the one prepared in example 2 is heated to 60° C. with moderate stirring and kept in recirculation so as to avoid local desiccation.

This composition is applied, for example using a roll doctor, onto an unbonded bleached kraft paper with a grammage of 60 g/m², at a rate of 15 g of composition per m² of kraft paper.

The paper thus coated is dried in a tunnel oven of the type conventionally used in the paper industry, and in which prevails a temperature of between 80 and 100° C. Next, it is left to cool before winding.

This paper has, after drying, a monolayer coating of 4 g/m² which gives it good barrier properties both with respect to oils and fats, and also with respect to water, as emerges from the example below.

### EXAMPLE 5

### Demonstration of the Barrier Properties of Substrates Treated with the Method in Accordance with the Invention

The value of the method for imparting oil- and fat-barrier properties to a substrate, combined, if so desired, with water-barrier and water-resistance properties, is demonstrated by coating 4 different substrates, with grammages of between 32 g/m² for the smallest and 220 g/m² for the largest, with one or more layers of a composition prepared in accordance with example 2 (A), optionally in combination with a layer of an ethanolic (absolute ethanol) 30% solution of dewaxed and bleached shellac (C), and by comparing the ability of the substrates thus coated to withstand penetration and transpiercing by a food oil (mixture of sunflower oil and rapeseed oil) on the one hand, and by acidified water (pH 4) supplemented with 1% of an anionic surfactant on the other hand, with that displayed by these same uncoated substrates (controls).

The coatings are produced by depositing, for example with a striated cylindrical bar by hand or with a device suitable for this purpose, the amount of coating products required to obtain the total coating weight after drying given in the table. The wet amount used for each layer is identical with this type of equipment. Each layer is dried, for example, in one minute in a pulsed-air oven at 80° C.

The results obtained are given in table I below, in which the following definitions apply:

control: the uncoated substrate,

(A): the substrate coated with one layer of a composition prepared according to example 2,

(A)+(C) : the substrate coated with one layer of a composition prepared according to example 2 and one layer of an ethanolic 30% solution of dewaxed and bleached shellac,

(A)+(A): the substrate coated with two layers of a composition prepared according to example 2,

(A)+(A)+(C) : the substrate coated with two layers of a composition prepared according to example 2 and one layer of an ethanolic 30% solution of dewaxed and bleached shellac.

These results are expressed in the form of grades resulting from summarizing several tests, and are between 0 and 5.

Penetration/Transpiercing

0: none/none

1: very slow/very small

2: slow/small

3: fairly slow/moderate

4: fast/large

5: very fast/total

The time for each test is set at 6 hours. The acidified water and the food oil are deposited on the surface of the substrate, on the treated-face side using a microsyringe, so as to deposit a drop of about 25 μl above the coated substrate. The transpiercing is estimated by observing the reverse side of the substrate after applying the drop of liquid.

TABLE I

| | | Penetration and | |
|---|---|---|---|
| | | transpiercing scores | |
| | total weight of | | Water pH 4 + |
| Type of | coating in g/m² | | 0.1% anionic |
| coating | (of dry products) | Food oil | surfactant |
| BUBBLE PAPER 32 g/m² | | | |
| Control | 0 | 5 | 5 |
| (A) | 3.5 | 2 | 3 |
| (A) + (C) | 6.5 | 1 | 1 |
| (A) + (A) | 7 | 0 | 1 |
| (A) + (A) + (C) | 10 | 0 | 0 |
| UNBONDED BLEACHED KRAFT PAPER 60 g/m² | | | |
| Control | 0 | 3 | |
| (A) | 4 0 2 | | |
| (A) + (C) | 7 | 0 | 0 |
| (A) + (A) | 8 | 0 | 0 |
| (A) + (A) + (C) | 11 | 0 | 0 |
| TWO-SIDED COATED CARD 150 g/m² | | | |
| Control | 0 | 5 | 3 |
| (A) | 4 | 0 | 1 |
| (A) + (C) | 7 | 0 | 0 |
| (A) + (A) | 8 | 0 | 0 |
| (A) + (A) + (C) | 11 | 0 | 0 |
| DOUBLE-AREA JET CARDBOARD 220 g/m² | | | |
| (coating on the coarse side) | | | |
| Control | 0 | 5 | 5 |
| (A) | 5 | 2 | 3 |
| (A) + (C) | 8 | 0 | 0 |
| (A) + (A) | 9 | 0 | 0 |
| (A) + (A) + (C) | 12 | 0 | 0 |

As emerges from the text hereinabove, the invention is in no way limited to the modes of implementation, production and application thereof which have just been described in greater detail; on the contrary, it encompasses all the variants thereof that may occur to a person skilled in the art, without departing from the context or scope of the present invention.

1. A composition that is useful for imparting barrier properties to a substrate, characterized in that it may be obtained by dispersing, at a temperature between room temperature and 70° C., at least one film-forming resin or gum, which is insoluble in water and soluble in at least one water-miscible solvent, in an aqueous solution containing at least one water-soluble and lipophobic film-forming compound chosen from proteins, polysaccharides and mixtures thereof, said composition having a temperature of between room temperature and 70° C.

2. The composition as claimed in claim 1, characterized in that the water-soluble and lipophobic film-forming compound is chosen from proteins.

3. The composition as claimed in claim 1 or 2, characterized in that the water-soluble and lipophobic film-forming compound is chosen from proteins of animal origin, and especially from gelatins, egg proteins and milk proteins.

4. The composition as claimed in claim 3, characterized in that the water-soluble and lipophobic film-forming compound is an A-type gelatin having a gel strength of between about 150 and 280 Bloom BS, this gelatin optionally being combined with another gelatin, having a gel strength of less than or equal to 100 Bloom BS, in a weight ratio of at least 1:1.

5. The composition as claimed in claim 4, characterized in that the dispersion of the film-forming resin or gum in the gelatin solution is performed with a gelatin solution brought to a temperature of between 40° C. and 70° C.

6. The composition as claimed in claim 1, characterized in that the water-soluble and lipophobic film-forming compound is a polysaccharide chosen from alginates and carrageenans.

7. The composition as claimed in claim 1, characterized in that the water-soluble and lipophobic film-forming compound is a mixture of proteins and polysaccharides.

8. The composition as claimed in claim 7, characterized in that the polysaccharides are present in an amount of less than or equal to 10% (w/w) relative to the water-soluble lipophobic film-forming compounds as a whole.

9. The composition as claimed in any one of the preceding claims, characterized in that the film-forming resin or gum is a resin or gum of natural or biotechnological origin.

10. The composition as claimed in claim 9, characterized in that the film-forming resin or gum is chosen from shellac, dammar resin or a mixture of the latter with sandarac gum or hydrogenated colophony.

11. The composition as claimed in claim 9, characterized in that the film-forming resin or gum is a dewaxed and bleached shellac.

12. The composition as claimed in any one of the preceding claims, characterized in that the film-forming resin or gum represents not more than 70% and preferably not more than 50% (w/w) of the amount of water-soluble and lipophobic film-forming compound(s) present in the composition.

13. The composition as claimed in any one of the preceding claims, characterized in that the film-forming resin or gum is dispersed in the aqueous solution containing the water-soluble and lipophobic film-forming compound, by adding a solution of this gum or resin in an effective water-miscible solvent, the solvent phase of which solution has a water content of not more than 5% and preferably not more than 1% (v/v).

14. The composition as claimed in claim 13, characterized in that the aqueous solution has a content of water-soluble and lipophobic film-forming compound(s) of between about 20 and 40% (w/v), while the solution of resin or gum in a water-miscible solvent has a content of film-forming resin(s) or gum(s) of between about 20 and 50% (w/v).

15. The composition as claimed in claim 13 or claim 14, characterized in that the film-forming resin or gum is in solution in a solvent chosen from C₁-C₄ monoaliphatic alcohols and especially in ethanol, carbonyl solvents, polyol ethers and glycerol.

16. The composition as claimed in claim 15, characterized in that the carbonyl solvents are chosen from acids and esters thereof; ketone solvents; and mixtures thereof.

17. The composition as claimed in any one of claims 1 to 12, characterized in that the film-forming resin or gum is in solution in a modified aqueous solution of this film-forming resin or gum, obtained by modifying the pH or the ionic strength of the medium so as to dissolve the resin or gum.

18. The composition as claimed in claim 17, characterized in that the film-forming resin or gum is present in the modified aqueous solution in an amount ranging from 20 to 50% (w/v).

19. The composition as claimed in any one of the preceding claims, characterized in that it comprises a plasticizer in proportions of not more than 30% (w/w) relative to the total amount of solids present in this composition.

20. The composition as claimed in claim 19, characterized in that the plasticizer is chosen from polyols approved “for food contact”, and especially from glycerol, sorbitol, mannitol, xylitol and glycol ethers.

21. The composition as claimed in any one of the preceding claims, characterized in that it comprises at least one adjuvant chosen from hydrophobic release agents, opacifiers, anti-oxidants, antimicrobial, antifoams agents, colorants, fillers and flavorings.

22. The composition as claimed in any one of the preceding claims, characterized in that it comprises at least one agent capable of insolubilizing the water-soluble and lipophobic film-forming compound, during the hot drying of this composition, said agent being present in proportions of not more than 15% (w/w) relative to the total amount of solids present in said composition.

23. The composition as claimed in claim 22, characterized in that the agent capable of insolubilizing the film-forming agent is chosen from calcium chloride, aluminum sulfate and aluminum, calcium, magnesium and zinc stearates.

24. The composition as claimed in any one of claims 1 to 21, characterized in that it comprises at least one agent capable of inducing the crosslinking of the water-soluble and lipophobic film-forming compound, during hot drying of this composition, said agent being present in proportions of not more than 5% (w/w) relative to the total amount of solids present in said composition.

25. A method for preparing a composition that is useful for imparting barrier properties to a substrate, characterized in that it comprises:
a) the dispersion of at least one film-forming resin or gum, which is insoluble in water and soluble in at least one water-miscible solvent, in an aqueous solution containing at least one water-soluble and lipophobic film-forming compound chosen from proteins, polysaccharides and mixtures thereof, said solution having a temperature of between room temperature and 70° C.; and optionally
b) the addition to the resulting mixture of at least one plasticizer and/or of at least one adjuvant chosen from hydrophobic release agents, opacifiers, anti-oxidants, antimicrobial, antifoams agents, colorants, fillers and flavorings.

26. The method as claimed in claim 25, characterized in that it comprises the incorporation into the composition:
either of at least one agent capable of insolubilizing the water-soluble and lipophobic film-forming compound, during the hot drying of the composition, in which case this incorporation is performed during step a) when this agent is water-insoluble, or after step b) in the opposite case;
or of at least one agent capable of inducing the crosslinking of said film-forming compound during the hot drying of the composition, in which case this incorporation is performed after step b), on condition that, in the event of a delayed use of the composition, this agent is incapable of reacting before said composition has dried.

27. The method as claimed in claim 25, characterized in that it comprises the application by spraying or by any other means:
either of an agent capable of insolubilizing the film-forming compound,
or of an agent capable of inducing the crosslinking or said film-forming compound,
after applying the formulation to the support and optionally drying it.

28. The method as claimed in claim 25, characterized in that it comprises partially or totally dehydrating the composition in order to conserve it in a form concentrated in active materials or in a dry form, followed by rehydrating it with a suitable volume of water in order to use it to coat a substrate.

29. The method as claimed in claim 28, characterized in that it comprises the incorporation into the composition, after rehydration of said composition:
either of at least one agent capable of insolubilizing the water-soluble and lipophobic film-forming compound, during the hot drying of the composition, in which case this agent is preferably a water-soluble agent;
or of at least one agent capable of inducing the crosslinking of said film-forming compound during the hot drying of the composition.

30. A kit or device that is useful for imparting barrier properties to a substrate and that comprises at least two compartments, characterized in that the first compartment contains a composition as claimed in any one of claims 1 to 24, while the second compartment contains at least one agent capable of insolublizing or of inducing the crosslinking of the water-soluble and lipophobic film-forming compound, present in said composition, during the hot drying of said composition.

31. A kit or device that is useful for imparting barrier properties to a substrate and that comprises at least two compartments, characterized in that the first compartment contains a composition as claimed in any one of claims 1 to 24, while the second compartment contains a film-forming resin or gum, which is preferably identical to the resin or gum present in said composition, dissolved in a suitable medium as defined in any one of claims 15 to 17.

32. A kit or device that is useful for imparting barrier properties to a substrate and that comprises at least two compartments, which kit is characterized in that the first compartment contains at least one water-soluble and lipophobic film-forming compound, optionally in aqueous solution, while the second compartment contains at least one film-forming resin or gum, dissolved in a suitable medium as defined in any one of claims 15 to 17.

33. The kit or device as claimed in claim 31 or claim 32, characterized in that the solution of film-forming resin or gum present in the second compartment has a content of film-forming resin(s) or gum(s) of between about 20 and 50% (w/v).

34. The kit or device as claimed in claim 33, characterized in that the film-forming gum is present in solution in an alcohol, in a carbonyl solvent, in a solvent of polyol ether type or in glycerol, the solvent phase having a water content of not more than 5% and, if possible, of not more than 1% (v/v).

35. A method for imparting barrier properties to a substrate, characterized in that it comprises the coating of this substrate with one or more layers of a composition as claimed in any one of claims 1 to 24, and the hot drying of this layer or these layers.

36. The method as claimed in claim 35, characterized in that it involves, prior to coating the substrate:
the rehydration of the composition with water until a solids content of between 10 and 60% (w/v) is obtained, when this composition is in dry form; or
the adjustment of the solids content of the composition to a value of between 10 and 60% (w/v), when this composition, although in wet form, does not have a suitable solids content.

37. The method as claimed in claim 35 or claim 36, characterized in that it comprises, prior to coating the substrate, the heating of this composition to a temperature such that the composition has a fluidity that allows it to be applied uniformly and homogeneously to said substrate.

38. The method as claimed in any one of claims 35 to 37, characterized in that each layer of composition applied to the substrate results from the application of an amount of composition of between 10 and 20 g of composition per m² of substrate.

39. The method as claimed in any one of claims 35 to 38, characterized in that it comprises:
either the spraying, onto the outermost layer of composition or between the various layers of this composition, of an agent capable of inducing the crosslinking of the water-soluble and lipophobic film-forming compound, present in this composition, said agent preferably being in the form of an aqueous solution;
or the depositing, onto the outermost layer of composition, of one or more layers of a solution containing at least one film-forming resin or gum, which is preferably identical to the resin or gum present in the composition, said solution preferably being as defined in claim 35;
or by applying a radiation treatment to the outermost layer of composition.

40. The method as claimed in any one of claims 35 to 39, characterized in that the substrate over the surface of which the composition is applied is a cellulosic substrate such as paper, cardboard, wood or textile based on cellulose fibers.

41. The use of a composition as claimed in any one of claims 1 to 24, of a kit or a device as claimed in any one of claims 30 to 34 or of a method as claimed in any one of claims 35 to 40, for producing wrappings, and especially wrappings intended for packaging foodstuffs.

42. A wrapping, characterized in that it may be obtained by performing the method as claimed in any one of claims 35 to 40.
